(19) United States
(12) Patent Application Publication
(10) Pub. No.: US 2026/0259921 A1
(43) Pub. Date: Sep. 3, 2026

(54) Systems and Methods of Secure Communication with a Document

(71) Applicant: Rogo Technologies, Inc., New York, NY (US)

(72) Inventors: Tumas Rackaitis, New York, NY (US); Eric Tu, New York, NY (US); Gabriel Stengel, New York, NY (US)

(21) Appl. No.: 19/552,195

(22) Filed: Feb. 27, 2026

Related U.S. Application Data
(60) Provisional application No. 63/765,496, filed on Feb. 28, 2025.

(51) Int. Cl. G06F 16/358; G06F 16/3329; G06F 16/334; G06F 40/289

(52) U.S. Cl. CPC G06F 16/358; G06F 16/3329; G06F 16/3347; G06F 40/289

(57) ABSTRACT

Methods and systems for secure communication with one or more documents are disclosed. A method for secure document communication in a local browser comprises: receiving, at the local browser, a document file and a user query, extracting content from the document file within the local browser, producing a plurality of chunks from the extracted content, building one or more search indexes based on the plurality of chunks, searching the index using a search query based on the user query to identify relevant chunks, generating a prompt that incorporates the user query the relevant chunks, and transmitting the prompt to a remote large language model (LLM) and, upon receiving a response from the LLM, rendering the response in the local browser.

### CROSS-REFERENCE TO RELATED APPLICATION

The present application claims the benefit of U.S. Provisional Application Ser. No. 63/765,496 filed on Feb. 28, 2025, which is incorporated herein by reference in its entirety for all purposes.

### TECHNICAL FIELD

The present invention relates generally to network communications and information security, and more particularly, the present disclosure is related to a system and method of analyzing and interacting with a document.

### BACKGROUND

In recent years, significant advancements have been made in natural language processing and artificial intelligence technologies. Large Language Models (LLMs) have emerged as powerful tools for understanding and generating human-like text based on provided context and queries. These models have been increasingly deployed in various applications, including document analysis, question answering, and conversational systems. A common architecture for document analysis systems involves extracting content from documents, storing this content in databases or vector stores on remote servers, and then providing interfaces through which users can query these stores using natural language. When a user submits a query, these systems typically process the query to understand intent, search document stores for relevant content, retrieve matching portions, generate responses based on the retrieved content, and present the response to the user with citations or references. Such systems have proven valuable for knowledge management, information retrieval, and document exploration tasks across various industries, including legal, medical, financial, and educational sectors.

Despite their utility, conventional document analysis systems suffer from several significant limitations related to privacy and security. The standard architecture requires uploading potentially sensitive documents to remote servers for processing, indexing, and storage. This approach creates security vulnerabilities where sensitive information might be exposed during transmission or storage, raises compliance concerns regarding data protection regulations such as GDPR, HIPAA, or financial regulations, requires users to trust third-party providers with potentially confidential information, and may violate organizational data retention policies or confidentiality agreements. Once documents are uploaded to remote systems, users typically have limited visibility into how their documents are stored, processed, or retained. It becomes difficult to ensure complete deletion of sensitive information if required, access controls may be inadequate for highly sensitive documents, and documents may be stored in jurisdictions with different legal protections than where they originated.

Attempts to process documents locally within web browsers have faced significant technical challenges that have limited their effectiveness as alternatives to server-based solutions. Browsers have limited computational capabilities compared to server environments, and memory constraints make it difficult to perform complex operations on large documents. Implementation of sophisticated search and retrieval mechanisms, particularly vector-based approaches, has been challenging within browser memory and processing constraints. Coordinating the various components required for document analysis presents architectural challenges in browser environments, often leading to compromises in functionality or performance.

There is a clear need for document analysis systems that maintain the privacy and security of sensitive documents by minimizing or eliminating the need to transmit document content to remote servers. Such systems should provide sophisticated search and retrieval capabilities comparable to server-based solutions, integrate effectively with modern language models for generating insightful responses, and function efficiently within the constraints of browser environments. They should offer intuitive user experiences for document exploration and information retrieval while enabling proper citation and navigation within source documents. A solution addressing these needs would serve the growing demand for secure, privacy-preserving document analysis tools across industries where document confidentiality is paramount while still providing the benefits of advanced language model capabilities.

Aspects of the present disclosed technology solve many of these challenges.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of a processing system, according to one embodiment of the invention;

FIG. 2 is a flow diagram illustrating example network communications of an operation of a prior system, according to one embodiment of the invention;

FIG. 3 is a flow diagram illustrating example network communications of an operation of the disclosed system, according to one embodiment of the invention; and

FIG. 4 is a schematic diagram of an example system for communicating with a document, according to one embodiment of the invention.

### SUMMARY

A summary of the present disclosed technology can be surmised by referring to the appended claims.

The disclosed system provides several practical applications and technical advantages that overcome the previously discussed technical problems. The following disclosure provides a practical application of a server that is configured to provide a responsive answer to a user query based on data contained within a document uploaded to the browser where the document does not leave the browser (i.e., is not transmitted to an external server for processing). The disclosed server provides practical applications that improve the information security concerning the data in a user's document by processing embeddings created based on the document in response to the query, not the actual document itself. This process provides a technical advantage that increases information security because it enables the uploaded document to be stored locally in the browser and not at an external server, thereby minimizing the risk of data leakage.

In an embodiment, a method for communicating with at least one document within a communication session with a browser comprises receiving a query from a user device. The method further comprises identifying one or more portions of text from the at least one document and categorizing the identified one or more portions of text into a plurality of chunks. The method further comprises transmitting the plurality of chunks to an embedding server and receiving a set of embedded chunks from the embedding server. The method further comprises performing a proximity search based on the query and the set of embedded chunks. The method further comprises transmitting results from the proximity search to an external large language model. The method further comprises receiving a response from the external large language model, wherein the response comprises an answer to the query and one or more citation tokens associated with the plurality of chunks. The method further comprises rendering the response on the browser.

Certain embodiments of this disclosure may include some, all, or none of these advantages. These advantages and other features will be more clearly understood from the following detailed description taken in conjunction with the accompanying drawings and claims.

### DETAILED DESCRIPTION

This disclosure provides solutions to the aforementioned and other problems of previous technology by analyzing and interacting with a document within a browser.

Although example embodiments of the present disclosure are explained in detail, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Moreover, titles or subtitles may be used in this specification for the convenience of a reader, which shall have no influence on the scope of the present disclosure.

The term “comprising” or “containing” or “including” is meant that at least the named element, material, or method step is present in the composition or article or method, but does not exclude the presence of other elements, materials, or method steps, even if the other such elements, material, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific embodiments or examples. In referring to the drawings, like numerals represent like elements throughout the several figures.

Various products and services provided by third parties are mentioned as example components of embodiments in accordance with the disclosed technologies. The use of trademarked (registered or common-law) names are intended for descriptive purposes only—no claim of ownership over those terms is asserted by the applicants by this application. Further, the mention of a trademarked product or service is as an example only. Other products and services providing equivalent functions, whether commercial, open-source, or custom-developed to support embodiments are contemplated in accordance with the disclosed technology.

Certain examples of the disclosed technology are discussed and shown herein using names, addresses, behavioral attributes, financial data, and other forms of personal data. All such data is fictitious. No actual personal data is provided herein. Any correspondence between data provided in this application and actual persons, living or dead, is purely coincidental. In addition, the examples of business metrics are merely examples. Embodiments of the present disclosed technology are not limited to merely these metrics.

In the context of this application “LLM” or “Large Language Model” refers to a machine learning model capable of receiving input in one or more input modalities, such as text, images, video, and/or audio, and producing output responsive to the input in one or more output modalities, such as text, images, video, and/or audio. Some LLM's can be implemented using a transformer model, diffusion techniques, state space models, or any other model architecture now know or developed in the future that is suitable for receiving input in one or more input modalities, and producing output in one or more output modalities.

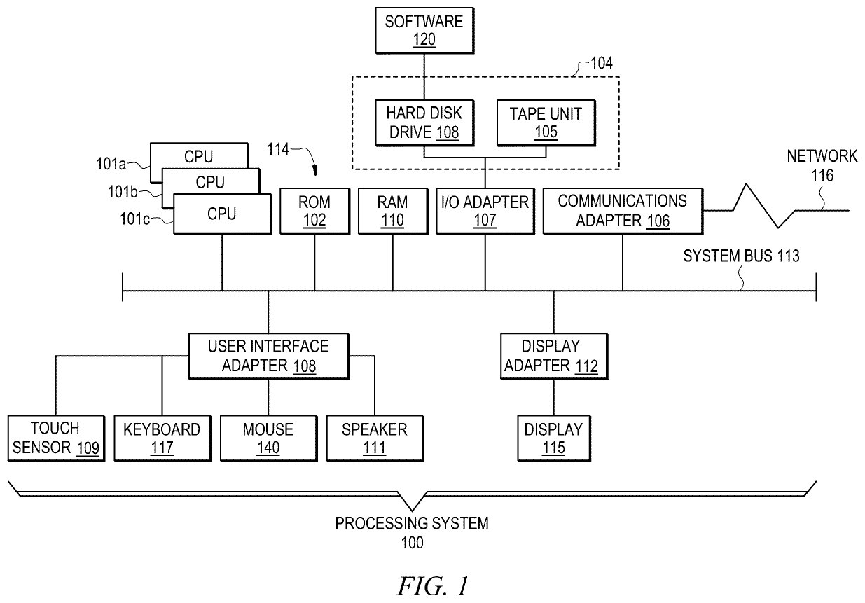

Referring now to FIG. 1, there is shown an embodiment of a processing system 100 for implementing the disclosed technology. In this embodiment, the processing system 100 has one or more central processing units (processors) 101a, 101b, 101c, etc. (collectively or generically referred to as processor(s) 101). Processors 101, also referred to as processing circuits, are coupled to system memory 114 and various other components via a system bus 113. Read only memory (ROM) 102 is coupled to system bus 113 and may include a basic input/output system (BIOS), which controls certain basic functions of the processing system 100. The system memory 114 can include ROM 102 and random access memory (RAM) 110, which is read-write memory coupled to system bus 113 for use by processors 101.

FIG. 1 further depicts an input/output (I/O) adapter 107 and a network adapter 106 coupled to the system bus 113. I/O adapter 107 may be a small computer system interface (SCSI) adapter that communicates with a hard disk (magnetic, solid state, or other kind of hard disk) 103 and/or tape storage drive 105 or any other similar component. 1/O adapter 107, hard disk 103, and tape storage drive 105 are collectively referred to herein as mass storage 104. Software 120 for execution on processing system 100 may be stored in mass storage 104. The mass storage 104 is an example of a tangible storage medium readable by the processors 101, where the software 120 is stored as instructions for execution by the processors 101 to implement a circuit and/or to perform a method, such as those shown in FIGS. 1-4. Network adapter 106 interconnects system bus 113 with an outside network 116 enabling processing system 100 to communicate with other such systems. A screen (e.g., a display monitor) 115 is connected to system bus 113 by display adapter 112, which may include a graphics controller to improve the performance of graphics intensive applications and a video controller. In one embodiment, adapters 107, 106, and 112 may be connected to one or more I/O buses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 117, mouse 140, and speaker 111 can be interconnected to system bus 113 via user interface adapter 108, which may include, for example, a chip integrating multiple device adapters into a single integrated circuit.

Thus, as configured in FIG. 1, processing system 100 includes processing capability in the form of processors 101, and, storage capability including system memory 114 and mass storage 104, input means such as a keyboard 117, mouse 140, or touch sensor 109 (including touch sensors 109 incorporated into displays 115), and output capability including speaker 111 and display 115.

In one embodiment, a portion of system memory 114 and mass storage 104 collectively store an operating system to coordinate the functions of the various components shown in FIG. 1.

### Prior Art

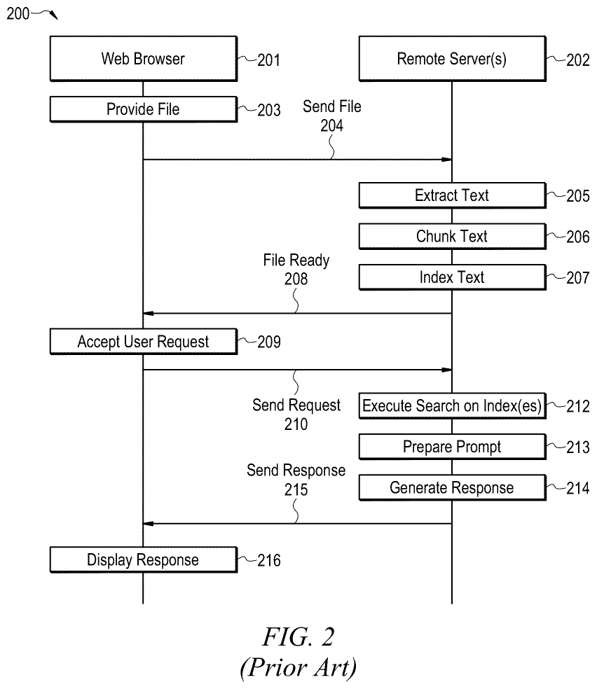

FIG. 2 is a sequence diagram illustrating a prior art method for allowing a user to ask questions of a document 200. In the prior art method, there is a local computer 201 which can execute a portion of the method locally in a web browser. The method begins by the user providing a file 203 to the local web browser. The local web browser then sends the file 204 to a remote server or set of servers 202. Once on the server, the server then extracts the text from the document 205, generates a plurality of chunks from the text 206, and indexes them 207 in a search index. The remote server or servers then notifies the web browser that the file is ready for search 208. A user can then submit a request 209 to the document, such as a question or task to be performed by the model. The request is then sent to remote server 202 in a transmission 210 to be used as a search query against the search indexes 212, producing a plurality of potentially relevant chunks to the request. The chunks and the request are then combined to produce a textual prompt 213 to submit to an AI model, such as a large language model, to generate a response 214. Once the response is generated, the generated response is sent back to the locally-running application or web browser 215. The web browser can then display the response 216 to the user.

This prior art method suffers from a number of deficiencies. Most notably, in order to operate correctly, the entire file must be sent to a remote server and stored on that server. This creates potential security issues, because the document may be obtained by malicious actors operating in the remote servers(s), or inadvertently disclosed to third parties through software errors or bugs. Further, this method may present compliance risks if the document to be requested contains confidential or trade secret information, or information subject to data privacy laws, such as the CPRA, GDPR, HIPAA, Gramm-Leach-Bliley Act, or other applicable laws. Therefore, there is a need for a way to provide a similar user experience without exposing potentially sensitive information to third parties, or storing such material on systems where malicious actors or software errors may result in inadvertent disclosure.

However, moving one or more of the functions currently performed by the Remote Server(s) to the web browser presents numerous technical challenges. Running software in a browser introduces unique challenges that differ significantly from operating on a remote server. One of the primary hurdles is the limitation of available resources. Browsers are designed to run on a wide range of client devices, from high-performance desktops to low-power mobile devices, which means memory, CPU, and storage can be severely constrained compared to the robust hardware typically found in server environments. This often necessitates careful management of resource usage, efficient coding practices, and sometimes even rewriting or adapting algorithms to ensure smooth performance within these constraints.

Another challenge is working with web APIs and the restrictions imposed by the browser sandbox. Browsers provide a variety of APIs for handling tasks like rendering graphics, managing user input, or interacting with local storage, but these APIs often come with limitations. For example, they might not provide the same level of control or flexibility as native system APIs available on a server, or there may be cross-browser compatibility issues that require additional effort to address. Moreover, security restrictions such as the Same-Origin Policy, which helps protect users by preventing malicious scripts from accessing data on different domains, can complicate how data is fetched and shared between different parts of an application. This contrasts with remote servers, where developers typically have more control over the environment and fewer constraints on resource access and communication.

In addition, browser-based software frequently relies on asynchronous programming models due to the need to maintain a responsive user interface. This can introduce complexity, as developers must carefully manage callbacks, promises, or async/await patterns to handle tasks such as network requests or background computations without freezing the UI. Remote servers, on the other hand, often operate in environments where asynchronous processing is more straightforward or can be offloaded to dedicated worker processes. Ultimately, these challenges require a different set of design considerations and strategies, making the development of browser-based software both a technically and creatively demanding endeavor.

Even substituting the web browser for a locally running desktop application presents similar challenges. Even though desktop applications often enjoy greater access to system resources and native APIs, developers still face significant hurdles. Just as with browsers, desktop applications must be optimized to run efficiently on a range of hardware configurations. Memory management, CPU utilization, and responsiveness remain critical concerns, especially as users expect modern applications to perform seamlessly while handling complex, concurrent tasks.

Moreover, the integration with native operating systems introduces its own set of challenges. Desktop applications must adhere to platform-specific conventions and security policies, which can complicate everything from UI design to low-level system access. Cross-platform compatibility, in particular, requires developers to navigate diverse frameworks and toolkits while ensuring that performance and user experience remain consistent across Windows, macOS, and Linux. This need for a unified yet adaptable approach mirrors the intricacies encountered when developing for the web, where browser inconsistencies and API limitations necessitate careful planning and abstraction.

Finally, regardless of whether an application runs in a browser or as a desktop program, the importance of asynchronous processing and robust error handling cannot be overstated. In both cases, ensuring that the user interface remains responsive—while background operations execute smoothly—requires thoughtful design of event loops and concurrency mechanisms. Balancing these technical demands with security, usability, and performance goals underscores the broader challenge facing developers today: delivering sophisticated software experiences in environments that are inherently constrained by both hardware limitations and system-level restrictions.

### Example Method

However, aspects of the present invention overcome many of these limitations, providing a more secure way of providing a similar user experience, while maintaining the privacy of the files used in the chat experience.

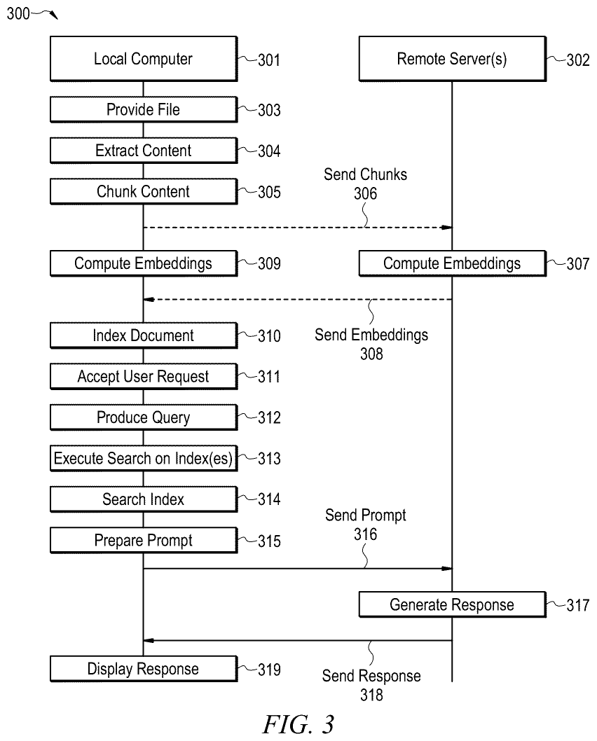

FIG. 3 illustrates an embodiment that provides such an experience, involving a local application or web browser 301 and one or more remote server(s) 302. The first set of procedures can be file ingestion, and includes the steps of providing a file 303, extracting the content from the file 304, and producing a plurality of chunks of that content 305.

Document ingestion can begin with the user providing a file 303. This file can be in a variety of formats, including but not limited to PDF, DOC/DOCX, TXT, JPEG, PNG, and CSV. Next, content can be extracted from the file 304. Content extraction is not limited to simple text parsing; it encompasses the identification and extraction of text, images, and tabular data. This multidimensional extraction process must be resilient enough to handle inconsistencies in file formatting and encoding, which is particularly challenging when operating in resource-constrained environments. To overcome these challenges, some embodiments can employ lightweight parsing libraries and incremental processing techniques. Utilizing modern web APIs, Typescript and/or WebAssembly modules, or even optimized native code can improve performance in some embodiments by offloading intensive tasks to background threads or web workers, thereby maintaining a responsive user interface.

Once the content is extracted, the content must be chunked 305 into manageable segments. Chunking may be performed using any chunking technique known in the art, including rule-based segmentation, statistical methods, sliding windows, or machine learning-based approaches that ensure semantic coherence. This segmentation is crucial for subsequent indexing and search operations in the secure chat system. However, executing complex chunking algorithms locally presents additional computational challenges compared to a remote server. To mitigate these issues, the system can leverage asynchronous processing and optimized algorithms that dynamically adjust to the available system resources. Such techniques ensure that even large files or documents containing mixed content types can be processed efficiently without compromising the application's overall performance or user experience.

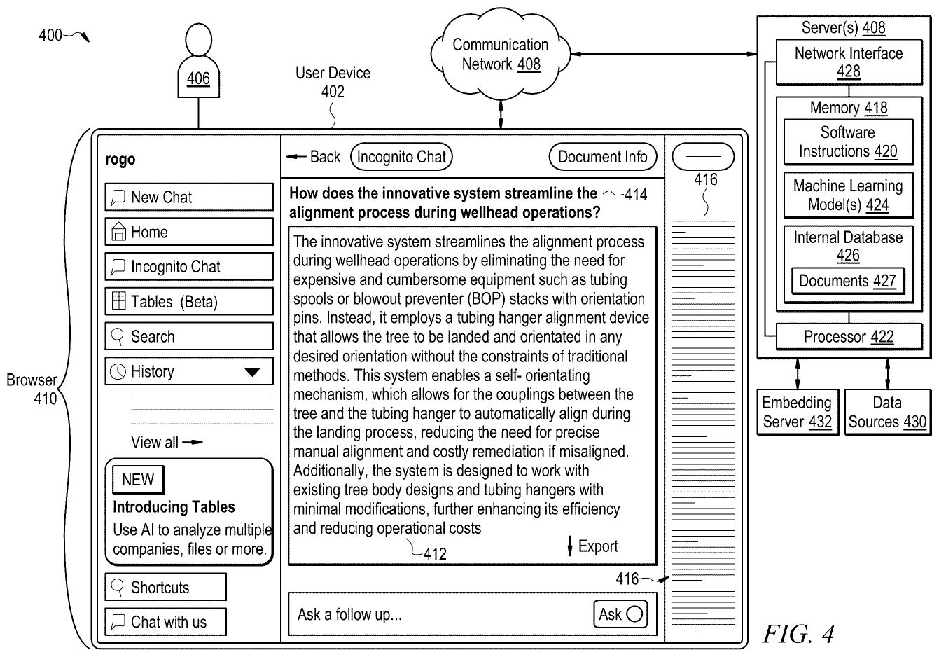

After chunking the content, some embodiments can move to indexing 310 where each content chunk is prepared for search. At this stage, the chunks—whether they consist of textual data or non-textual data such as images and tables—may be transformed into different representations depending on the chosen search index. Without limitations, any suitable methods for computing semantic meaning may be utilized, such as embedding, attention, tokenization, etc. For example, if a table is detected, statistics and/or numerical values may be computed for quantitative questions. For vector-based search indexes, embeddings can be computed. This computation can occur remotely by sending the chunks 306 to a remote embedding server (i.e., either to a separate embedding server or server 404 as discussed in FIG. 4) to compute embeddings 307, and return embeddings for the chunks 308. In some embodiments, the embedding can be performed locally 309. In some embodiments, sparse vector techniques like TF-IDF or BM25 can be used to directly index tokenized data without the need for embedding.

Once the necessary representations have been computed, the next step is to index the document 310 by storing both the raw and embedded data in one or more search indexes. The system can be designed to support various configurations, including vector search databases, TF-IDF/BM25 indexes, or a hybrid index that leverage a variety of approaches. In a hybrid setup, multiple indexes might be maintained concurrently, necessitating a results fusion process such as a reciprocal reranking algorithm, or a reranker model to synthesize search outcomes from different sources into a coherent response. In some embodiments, a reranker model can be used running on the local computer if compute resources allow. In some embodiments, the search results from several indexes can be transmitted to a remote server capable of running the reranker model to synthesize the results from multiple search indexes into a single coherent list of search results.

Implementing this indexing process within a locally running application or web browser poses unique challenges compared to a remote server environment. Local environments often have limited processing power and memory, which can impact the performance of computationally intensive tasks like embedding generation. To overcome these limitations, the system can adopt techniques such as asynchronous processing and the use of web workers or optimized native code, ensuring that embedding computations do not block the user interface. Furthermore, in some embodiments, the system may dynamically decide whether to compute embeddings locally 309 or delegate the task to a remote server 302 based on resource availability.

In some embodiments, a HNSW (Hierarchical Navigable Small World) index can be constructed locally. HNSW is a graph-based algorithm designed for approximate k-nearest neighbor (KNN) search, which is particularly useful for applications requiring fast, scalable retrieval of semantically similar items. In local environments such as web browsers or desktop applications, leveraging HNSW involves adapting the algorithm to work within the confines of limited memory, reduced processing power, and the inherent performance constraints of client-side environments. For instance, while HNSW is well-suited for indexing high-dimensional vectors—be they derived from textual, visual, or tabular data—the process of constructing and querying its multi-layer graph structure must be finely tuned to avoid excessive resource consumption.

In some embodiments, these limitations can be mitigated by using Typescript and/or WebAssembly. By compiling an optimized implementation of HNSW (or similar algorithms) from a low-level language like C++ into Typescript and/or WebAssembly, developers can achieve suitable execution performance in the browser. This can allow for efficient handling of large vector datasets and complex computations that would otherwise be too resource-intensive if implemented purely in JavaScript. For locally installed desktop applications, integrating native libraries or bindings that harness the power of the underlying hardware can similarly provide the computational efficiency needed for fast ANN searches.

In some embodiments, techniques such as lazy loading and incremental index building can help reduce resource intensity. These approaches allow the system to load only necessary portions of the index on demand, reducing the overall memory footprint and ensuring that the application remains responsive during both indexing and query processing. Asynchronous processing and the use of web workers can further aid in distributing the computational load, ensuring that the user interface remains fluid even when handling intensive tasks.

Other approximate KNN techniques can be used in embodiments, such as Annoy or IVF-based methods. These techniques offer alternative trade-offs in terms of index build time, memory usage, and query performance. In some cases, combining multiple methods into a hybrid search index can yield improved accuracy and efficiency, with a results fusion process—potentially involving a reranker model—merging the strengths of each individual approach. Ultimately, the deployment of HNSW and similar algorithms in browser-based or local applications requires a balance between computational demands and available resources, achieved through strategic use of modern web technologies, asynchronous design patterns, and hybrid processing strategies.

Once the search index or indices are prepared, some embodiments can receive a request for a response from a user. First, a request 311 from the user is captured. In some embodiments, the request from the user can be directly used as a search query against the search indexes to produce a set of responsive chunks. In some embodiments, the user request can undergo a query preprocessing step 312 to produce an appropriate query for the search indexes. This preprocessing can employ NLP techniques such as keyword extraction, entity recognition, or even syntactic parsing to distill the essence of the request. Alternatively, the system may delegate this task to a remote LLM, which can generate a more refined query that better captures the user's intent.

Following query generation, the system executes a search 313 on the available indexes. In this process, the search of the indices 314 returns a set of k top chunks along with their associated relevance scores. These relevance scores can help determine which chunks are most pertinent to the user's request, allowing for a focused and contextually relevant prompt. Once these chunks are identified, the system can prepare a prompt 315 by fusing the user's request with the top-ranked search results, ensuring that the remote LLM receives a rich and informative context to generate a high-quality response.

Implementing these processes in a local environment, such as a browser or desktop application, introduces several challenges. The computationally intensive nature of NLP preprocessing, search execution, and prompt preparation may strain local resources like memory and CPU. To overcome these limitations, the system can employ asynchronous processing techniques and utilize web workers or background threads to handle heavy computation without freezing the user interface. Additionally, when resource constraints are particularly severe, the system may opt to offload certain tasks—such as advanced query formulation—to remote servers, thereby striking a balance between local responsiveness and computational power. This adaptive approach ensures that even within a resource-limited local environment, user responses are efficiently processed and transformed into effective prompts for remote LLM generation.

In some embodiments, the user query and search results can be combined and used to prepare the input for a remote LLM in a prompt preparation phase 315. In this phase, the system constructs a comprehensive prompt that encapsulates the necessary context for the LLM to generate a meaningful response. This prompt is composed of a predefined system prompt, the user's query, and a list of the most relevant document chunks derived from the earlier search process. In some embodiments, each chunk can be annotated with one or more of a unique chunk ID, its source document, its rank based on relevance, and an associated relevancy score. By consolidating these elements, the system ensures that the LLM receives a contextually aware input that can guide its response generation accurately.

In some embodiments, the final prompt can be prepared using a templating approach to dynamically assemble this prompt. For instance, the system may define a base system prompt that sets the context and tone for the LLM, wrap the user query with additional instructions if necessary, and iterate over the retrieved chunks to present their details in an organized manner. This structured presentation aids in ensuring that the LLM can reference the correct document context and weigh the importance of each chunk based on its provided metadata.

Below is an example Jinja2 template that demonstrates how the prompt can be structured. This template includes a system prompt, the user query, and a list of the top relevant chunks with each chunk's unique identifier, source document, rank, relevancy score, and content: While this example uses Jinja2, use of that templating language is not essential to the claimed invention, and other templating languages and systems can be used without departing from the scope of the invention.
System Prompt:
{{system_prompt}}
User Query:
{{user_query}}
Relevant Chunks:
{% for chunk in chunks %}
Chunk ID: {{chunk. id}}
   Source Document: {{chunk.source}}
   Rank: {{chunk.rank}}
   Relevancy Score: {{chunk.relevancy}}
   Content: {{chunk.content}}
{% end for %}

This non-limiting example illustrates how to combine multiple pieces of data into a single prompt. The system prompt sets the overall context, while the user query is directly inserted to capture the user's intent. The for-loop iterates over the collection of chunks, listing each with its associated metadata. This structured approach not only organizes the data for the LLM but also provides clear signals on the priority and origin of the content, thereby enhancing the quality of the generated response.

After the prompt has been fully prepared, the next stage involves transmitting it to the remote server 316. The prompt—comprising the system prompt, user query, and curated document chunks—is sent to the remote server. Once the remote server receives the prompt, the LLM is invoked to generate a response 317. The remote LLM processes the prompt, drawing on its extensive training to produce a coherent and contextually relevant answer. Given that LLMs can be computationally intensive, this step benefits from the robust processing capabilities available in a server environment.

The generated response is then sent back to the local computer in element 318. In some embodiments, the LLM can produce a single complete response to be sent to the local computer 318. In some embodiments, the LLM may stream individual chunks of the response as they are generated to produce a more responsive user experience. Once the response is received, it is processed and handed off to the display mechanism of the local application or browser environment, as specified in element 319. The local system then renders the response for the user, ensuring that the output is presented in a clear and accessible format. This final step completes the round trip—from the user's initial query, through secure processing and remote generation, to the display of a refined answer—demonstrating how the integration of local and remote processing elements can be effectively orchestrated to deliver a high-quality chat-with-file experience.

### Example System

FIG. 4 illustrates a schematic diagram of an embodiment system 400 that is generally configured to render and display a responsive answer to a user query on a user device 402. The system 400 can include the user device 402 and a server 404. A user 406 can be associated with the user device 402. The components of system 400 can be communicatively coupled to each other through a communication network 408 and can be operable to transmit data between the user device 402 and the server 404 through the communication network 408. In general, the system 400 can improve electronic interaction technologies by analyzing and interacting with a document locally on the user device 402 within a browser 410 rather than transmitting said document to an external device, thereby decreasing the risk of unauthorized access to data.

For example, in a particular embodiment, a user (for example, the user 406) can attempt to engage in a “chat-with-file” feature to request a responsive answer 412 from a query 414 where input data is provided by a document 416 locally uploaded and stored in the browser 410. In this example, the user 406 can access the browser 410 through an instance of a software application installed on the user device 402. Once accessed, the user 406 can select one or more documents to be uploaded that will provide the input data. Without limitations, any suitable file type can be used for the one or more documents. For example, the user 406 can upload one or more documents as an html file, a pdf file, a doc or docx file, a pptx file, a txt file, a xls or xlsx file, a xml file, and the like. Once the one or more documents are uploaded, the user 406 can be prompted to input a query. After the query is input and submitted through the browser 410, the system 400 can proceed to index the data provided by the one or more documents and provide a responsive answer from the server 404 to be rendered on the user device 402.

The server 404 is generally a suitable server or plurality of servers (e.g., including a physical server and/or virtual server) operable to store data in a memory 418 and/or provide access to application(s) or other services. The server 404 can be a backend server associated with a particular group that facilitates conducting interactions between entities and one or more users. Details of the operations of the server 404 are described in conjunction with FIG. 3. Memory 418 includes software instructions 420 that, when executed by a processor 422, cause the server 404 to perform one or more functions described herein. Memory 418 can be volatile or non-volatile and can comprise a read-only memory (ROM), random-access memory (RAM), ternary content-addressable memory (TCAM), dynamic random-access memory (DRAM), and static random-access memory (SRAM). Memory 418 can be implemented using one or more disks, tape drives, solid-state drives, and/or the like. Memory 418 is operable to store software instructions 420, one or more machine learning models 424, one or more internal databases 426, and/or any other data or instructions. The software instructions 420 can comprise any suitable set of instructions, logic, rules, or code operable to execute the processor 422. In these examples, the processor 422 can be communicatively coupled to the memory 418 and can access the memory 418 for these determinations.

The one or more machine learning models 424 can be configured to receive input data and generate an output. Without limitations, any suitable model can be used as the one or more machine learning models 424. For example, the one or more machine learning models 424 can include supervised or unsupervised algorithms. In certain embodiments, the one or more machine learning models 424 can comprise an LLM. While illustrated as being stored on the server 404, the present disclosure is not limited to such a configuration. For example, the one or more machine learning models 424 can be stored external to the server 404 but communicatively coupled to and accessible by the server 404.

The one or more internal databases 426 can be any suitable component configured to store data, wherein the data can be any suitable type or file format. For example, the one or more internal databases 126 can be configured to store financial documents 427 associated with an entity (for example, a publicly traded company). Without limitations, the financial documents 427 can comprise 10K, 10Q or other SEC filings, investor conference call transcripts, presentations, videos, blogs, posts, and the like. The financial documents 427 can be collected and/or received from one or more data sources 430 external to the server 404.

As illustrated, the server 404 can further comprise a network interface 428. Network interface 428 is configured to enable wired and/or wireless communications (e.g., via communication network 408). The network interface 428 is configured to communicate data between the server 404 and other devices (e.g., user device 402, an embedding server 432), databases (e.g., one or more data sources 430), systems, or domain(s). For example, the network interface 428 can comprise a WIFI interface, a local area network (LAN) interface, a wide area network (WAN) interface, a modem, a switch, or a router. The processor 422 is configured to send and receive data using the network interface 428. The network interface 428 can be configured to use any suitable type of communication protocol as would be appreciated by one of skill in the art.

The communication network 408 can facilitate communication within the system 400. This disclosure contemplates the communication network 408 being any suitable network operable to facilitate communication between the user device 402, server 404, embedding server 432, and data sources 430. Communication network 408 can include any interconnecting system capable of transmitting audio, video, signals, data, messages, or any combination of the preceding. Communication network 408 can include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a POT network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system 400. In other embodiments, system 400 can not have all of these components and/or can have other elements instead of, or in addition to, those above.

The user device 402 can be any computing device configured to communicate with other devices, such as a server (e.g., server 404), databases, etc. through the communication network 408. The user device 402 can be configured to perform specific functions described herein and interact with server 404, e.g., via user interfaces. The user device 402 can be a hardware device that is generally configured to provide hardware and software resources to a user. Examples of a user device include, but are not limited to, a laptop, a computer, a smartphone, a tablet, a smart device, or any other suitable type of device. The user device 402 can comprise a graphical user interface (e.g., a display), a touchscreen, a touchpad, keys, buttons, a mouse, or any other suitable type of hardware that allows a user to view data and/or to provide inputs into the user device. User device 402 can be configured to allow a user to send requests to the server 404 or to another user device.

Technical advantages of certain embodiments of this disclosure may include one or more of the following. The present disclosure provides a practical application of a server that is configured to provide a responsive answer to a user query based on data contained within a document uploaded to the browser where the document does not leave the browser (i.e., is not transmitted to an external server for processing). The disclosed server provides practical applications that improve the information security concerning the data in a user's document by processing embeddings created based on the document in response to the query, not the actual document itself. This process provides a technical advantage that increases information security because it enables the uploaded document to be stored locally in the browser and not at an external server, thereby minimizing the risk of data leakage.

Other technical advantages will be readily apparent to one skilled in the art from the following figures, descriptions, and claims. Moreover, while specific advantages have been enumerated above, various embodiments may include all, some, or none of the enumerated advantages.

In an embodiment, a method for secure document communication in a local browser comprises: (a) receiving, at the local browser, a document file and a user query, (b) extracting content from the document file within the local browser, (c) producing a plurality of chunks from the extracted content, (d) building one or more search indexes based on the plurality of chunks, (e) searching the one or more search indexes using a search query based on the user query to identify relevant chunks, (f) generating a prompt that incorporates the user query the relevant chunks, and (g) transmitting the prompt to a remote large language model (LLM) and, upon receiving a response from the LLM, rendering the response in the local browser.

In one or more embodiments of the method, extracting the content comprises identifying and extracting text, images, and tabular data from the document file.

In one or more embodiments of the method, segmenting the extracted content into a plurality of chunks is performed using a rule-based segmentation technique.

In one or more embodiments of the method, segmenting the extracted content further comprises applying machine learning-based segmentation to ensure semantic coherence of the chunks.

In one or more embodiments of the method, producing the plurality of chunks comprises executing an embedding computation locally using a Typescript and/or WebAssembly module to accelerate processing within the browser.

In one or more embodiments of the method, producing the plurality of chunks further comprises selectively offloading the embedding computation to a remote embedding server when the local browser's processing power or memory is insufficient.

In one or more embodiments of the method, searching the one or more search indexes comprises performing a proximity search to execute a vector-based search algorithm that identifies chunks having a relevance score exceeding a predetermined threshold relative to the user query.

In one or more embodiments of the method, generating the prompt comprises incorporating a predefined system prompt, the user query, and metadata associated with each relevant chunk including a unique identifier, source information, and a relevance score.

In one or more embodiments of the method, the method further comprises performing content extraction and chunk segmentation asynchronously using web workers to maintain a responsive user interface within the local browser.

In one or more embodiments of the method, the method further comprises dynamically determining, based on available local processing resources, whether to compute the embeddings locally or to delegate the computation to a remote embedding server.

In one or more embodiments of the method, the document file is retained exclusively within the local browser and is not transmitted to any external server.

In one or more embodiments of the method, the method further comprises constructing, within the local browser, a hierarchical navigable small world (HNSW) index from the plurality of chunks.

In one or more embodiments of the method, the method further comprises fusing search results obtained from multiple indexes, wherein the fused results are used to generate a comprehensive prompt for the remote large language model.

In another embodiment, a system for secure document communication in a local browser comprises: one or more memories having computer readable computer instructions; and one or more processors for executing the computer readable computer instructions to perform a method. The performed method comprises: (a) receiving, at the local browser, a document file and a user query, (b) extracting content from the document file within the local browser, (c) producing a plurality of chunks from the extracted content, (d) building one or more search indexes based on the plurality of chunks, (e) searching the one or more search indexes using a search query based on the user query to identify relevant chunks, (f) generating a prompt that incorporates the user query the relevant chunks, and (g) transmitting the prompt to a remote large language model (LLM) and, upon receiving a response from the LLM that includes citation tokens, rendering the response in the local browser.

In one or more embodiments of the system, extracting the content comprises identifying and extracting text, images, and tabular data from the document file.

In one or more embodiments of the system, segmenting the extracted content into a plurality of chunks is performed using a rule-based segmentation technique.

In one or more embodiments of the system, segmenting the extracted content further comprises applying machine learning-based segmentation to ensure semantic coherence of the chunks.

In one or more embodiments of the system, producing the plurality of chunks comprises executing an embedding computation locally using a Typescript and/or WebAssembly module to accelerate processing within the browser.

In one or more embodiments of the system, producing the plurality of chunks further comprises selectively offloading the embedding computation to a remote embedding server when the local browser's processing power or memory is insufficient.

In one or more embodiments of the system, searching the one or more search indexes comprises performing a proximity search to execute a vector-based search algorithm that identifies chunks having a relevance score exceeding a predetermined threshold relative to the user query.

In one or more embodiments of the system, generating the prompt comprises incorporating a predefined system prompt, the user query, and metadata associated with each relevant chunk including a unique identifier, source information, and a relevance score.

In one or more embodiments of the system, the performed method further comprises performing content extraction and chunk segmentation asynchronously using web workers to maintain a responsive user interface within the local browser.

In one or more embodiments of the system, the performed method further comprises dynamically determining, based on available local processing resources, whether to compute the embeddings locally or to delegate the computation to a remote embedding server.

In one or more embodiments of the system, the document file is retained exclusively within the local browser and is not transmitted to any external server.

In one or more embodiments of the system, the performed method further comprises constructing, within the local browser, a hierarchical navigable small world (HNSW) index from the plurality of chunks.

In one or more embodiments of the system, the performed method further comprises fusing search results obtained from multiple indexes, wherein the fused results are used to generate a comprehensive prompt for the remote large language model.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Although the present disclosure and its advantages have been described in detail, it should be understood that various changes, substitutions and alterations can be made herein without departing from the spirit and scope of the disclosure as defined by the following claims.

In the foregoing specification, embodiments of the present disclosure have been described with reference to numerous specific details that may vary from implementation to implementation. The specification and drawings are, accordingly, to be regarded in an illustrative rather than a restrictive sense. The sole and exclusive indicator of the scope of the present disclosure, and what is intended by the applicants to be the scope of the present disclosure, is the literal and equivalent scope of the set of claims that issue from this application, in the specific form in which such claims issue, including any subsequent correction.

1. A method for secure document communication in a local browser, the method comprising:
(a) receiving, at the local browser, a document file and a user query,
(b) extracting content from the document file within the local browser,
(c) producing a plurality of chunks from the extracted content,
(d) building one or more search indexes based on the plurality of chunks,
(e) searching the one or more search indexes using a search query based on the user query to identify relevant chunks,
(f) generating a prompt that incorporates the user query the relevant chunks, and
(g) transmitting the prompt to a remote large language model (LLM) and, upon receiving a response from the LLM, rendering the response in the local browser.

2. The method of claim 1, wherein extracting the content comprises identifying and extracting text, images, and tabular data from the document file.

3. The method of claim 1, wherein producing the plurality of chunks is performed using a rule-based segmentation technique.

4. The method of claim 1, wherein producing the plurality of chunks further comprises applying machine learning-based segmentation to ensure semantic coherence of the plurality of chunks.

5. The method of claim 1, further comprising:
generating embeddings associated with the plurality of chunks; and
dynamically determining, based on available local processing resources, whether to generate the embeddings locally or to delegate computation to a remote embedding server.

6. The method of claim 5, further comprising selectively offloading the computation to the remote embedding server when the local browser's processing power or memory is insufficient.

7. The method of claim 1, wherein searching the one or more search indexes comprises performing a proximity search to execute a vector-based search algorithm that identifies chunks having a relevance score exceeding a predetermined threshold relative to the user query.

8. The method of claim 1, wherein generating the prompt comprises incorporating a predefined system prompt, the user query, and metadata associated with each relevant chunk including a unique identifier, source information, and a relevance score.

9. The method of claim 1, further comprising performing content extraction and chunk segmentation asynchronously using web workers to maintain a responsive user interface within the local browser.

10. The method of claim 1, wherein the document file is retained exclusively within the local browser and is not transmitted to any external server.

11. A system for secure document communication in a local browser, the system comprising:
one or more memories having computer readable computer instructions; and
one or more processors for executing the computer readable computer instructions to perform a method comprising:
(a) receiving, at the local browser, a document file and a user query,
(b) extracting content from the document file within the local browser,
(c) producing a plurality of chunks from the extracted content,
(d) building one or more search indexes based on the plurality of chunks,
(e) searching the one or more search indexes using a search query based on the user query to identify relevant chunks,
(f) generating a prompt that incorporates the user query the relevant chunks, and
(g) transmitting the prompt to a remote large language model (LLM) and, upon receiving a response from the LLM that includes citation tokens, rendering the response in the local browser.

12. The system of claim 11, wherein extracting the content comprises identifying and extracting text, images, and tabular data from the document file.

13. The system of claim 11, wherein producing the plurality of chunks is performed using a rule-based segmentation technique.

14. The system of claim 11, wherein producing the plurality of chunks further comprises applying machine learning-based segmentation to ensure semantic coherence of the plurality of chunks.

15. The system of claim 11, further comprising:
generating embeddings associated with the plurality of chunks; and
dynamically determining, based on available local processing resources, whether to generate the embeddings locally or to delegate computation to a remote embedding server.

16. The system of claim 15, further comprising selectively offloading the computation to the remote embedding server when the local browser's processing power or memory is insufficient.

17. The system of claim 11, wherein searching the one or more search indexes comprises performing a proximity search to execute a vector-based search algorithm that identifies chunks having a relevance score exceeding a predetermined threshold relative to the user query.

18. The system of claim 11, wherein generating the prompt comprises incorporating a predefined system prompt, the user query, and metadata associated with each relevant chunk including a unique identifier, source information, and a relevance score.

19. The system of claim 11, further comprising performing content extraction and chunk segmentation asynchronously using web workers to maintain a responsive user interface within the local browser.

20. The system of claim 11, wherein the document file is retained exclusively within the local browser and is not transmitted to any external server.
